(19) United States
(12) Patent Application Publication
(10) Pub. No.: US 2004/0169757 A1
(43) Pub. Date: Sep. 2, 2004

(54) Digialbum

(76) Inventor: Aremi M. Amachree, Garfield, NJ (US)

Correspondence Address: AREMI M. AMACHREE, P O BOX 426, BOGOTA, NJ, 07603, US

(21) Appl. No.: 10/730,869

(22) Filed: Dec. 6, 2003

Related U.S. Application Data
(60) Provisional application No. 60/431,329, filed on Dec. 7, 2002.

(51) Int. Cl. H04N 5/222

(52) U.S. Cl. 348/333.05; 348/211.3; 348/333.02

(57) ABSTRACT

High performance digital cameras today are increasingly directed towards parallelism in the snap and store of digital photos. As the trend towards faster snap rates continues so too is the ability to store these photos concurrently. Although, these simultaneous occurrences of snap and store are visited previously, a permanent, economical and more viable technology to view/display and store these photos has not been previously investigated.

Here, I present a technology which get digital image files directly from a digital camera or memory card drive for the purpose of viewing/displaying and storing these photos, which is permanent, economical and viable innovation. The average person spends couple of hundreds of dollars to print photos every year; this innovation will only require a one time investment in ones life time and will not compromise spending hard earned money on photo printing anymore.

With this innovation, the average person will most likely print less than 5 percent of his/her lifetime photo shots. That is a 95 percent savings, not to mention papers and ink saved.

### RELATED APPLICATIONS

This application takes the benefit of the filing date of the U.S. Provisional Patent No. 60/431,329, filed on Dec. 7, 2002.

### FIELD OF THE INVENTION

The present invention relates generally to the view/display of digital/analog images and pictures; more so, to store those files.

### INTRODUCTION

Recent research has focused on Digital Cameras and their performances with added capacity to hold or to store more shots. Until now, no research has focused on how these digital cameras can be more beneficial to the owner/user; more especially, on how to view these photos without waiting on the “Big Corporations” to print them. In fact these photos need not be printed if they are not to be hang on the wall or to be placed on a desktop. Nevertheless these photos can still be hanged or placed on a desktop without ‘printing’ as discussed below.

This paper proposes a solution to those problems facing digital camera users; we all love taking photographs. Taking photographs is an adventure not a crime. The purpose of this solution is not to bankrupt the “Big Corporations” that depend on photo printing, but to appreciate and explore modem technologies and at the same time, allowing the users of digital cameras to get the full benefit of their technology.

### SUMMARY OF THE INVENTION

A digital photo album called DigiAlbum, capable of viewing/displaying and storing of digital images and pictures; more importantly, taking digital image files directly from the digital camera. Furthermore, coupled with memory card drives. The present invention is intended to displace the current paper photo album without wasting any benefit from the paper version but rather adding benefits and lots of cost savings.

### BRIEF DESCRIPTION OF THE SEVERAL VIEWS OF THE DRAWING

The present invention will be more understood with a brief description of each drawing. However, this should not be taken in a light manner to limit the present invention.

FIG. 1: illustrates the top-level structure of the DigiAlbum.

FIG. 2: illustrates the top-level structure of the DigiAlbum I/O.

FIG. 3A: illustrates the top-level structure of the DigiAlbum CPU.

FIG. 3B: illustrates the top-level structure of the DigiAlbum CPU block diagram on a System bus.

FIG. 4: illustrates the top-level structure of the DigiAlbum System bus.

FIG. 5: illustrates the top-level structure of the DigiAlbum input devices.

FIG. 6: illustrates a top-level structure of the DigiAlbum output unit.

FIG. 7: illustrates a top-level structure of the DigiAlbum Bi-directional I/O devices.

FIG. 8: illustrates Type 1 of the System Bus, incorporated with some DigiAlbum features.

FIG. 9: illustrates Type 2 of the System Bus, incorporated with some DigiAlbum features.

FIG. 10: illustrates Type 3 of the System Bus, incorporated with most DigiAlbum features.

FIG. 11: illustrates Type 4 of the System Bus, incorporated with most DigiAlbum features. This Bus is incorporated with the DigiNote.

FIG. 12: illustrates the top-level structure of the DigiAlbum LCD on a DigiNote and its abstract.

FIG. 13: illustrates the front view of the DigiAlbum LCD.

FIG. 14: illustrates the DigiNote top structure with the LCD features.

FIG. 15: Deleted

FIG. 16: illustrates all the different variations of the DigiAlbum in its complete form.

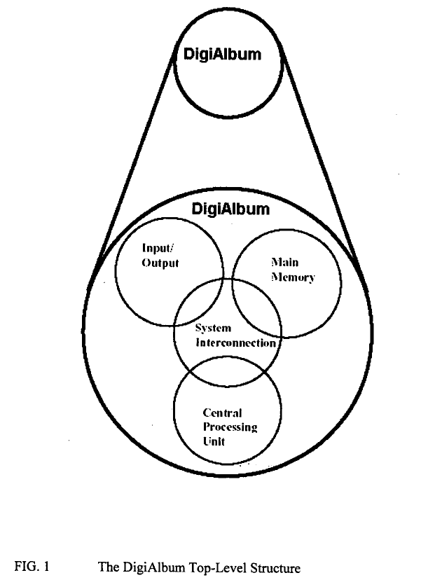

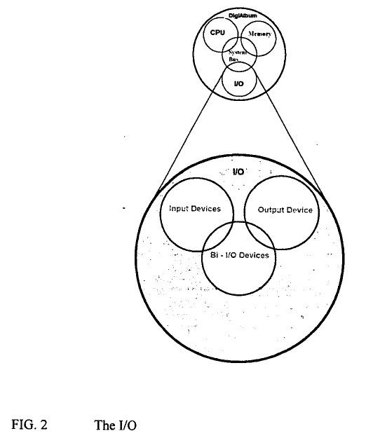

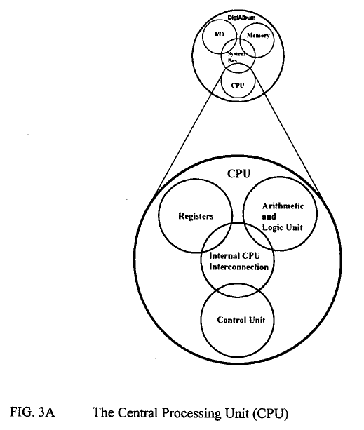

### DETAILED DESCRIPTION OF THE INVENTION DIGIALBUM

The digital album; Imagine a DigiAlbum desktop in your living room, bedroom or anywhere even at work; or a DigiNote, or a DigiAlbum handheld or a DigiAlbum flat panel wall mount on your wall that could allow you, your family, and all your friends and visitors to view those lovely memories of yours without waiting for a paper print. These are the actual purposes of this innovation and with the ability to store and manipulate those photos.

The details that are needed to develop these systems are explained now.

The DigiAlbum would require:

Processor (“COMPUTER”)

Hard drive

CD-drive

Control buttons

Power supply

Port to connect to external computer

Drives to insert a digital camera memory cards/sticks or any memory cards/sticks

Port to connect a digital camera (DCDA port) and

Other necessary ports

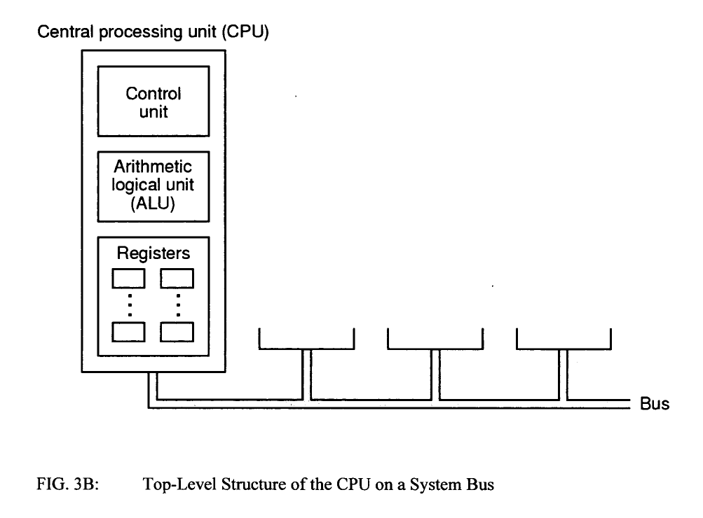

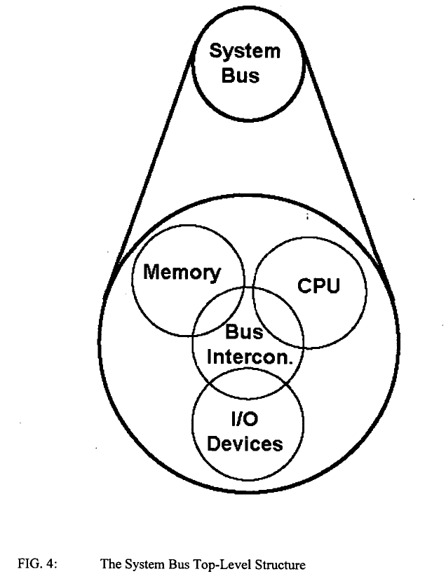

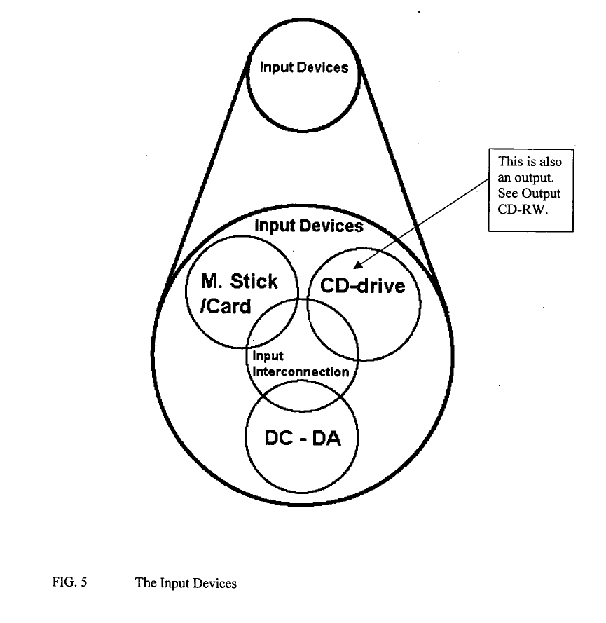

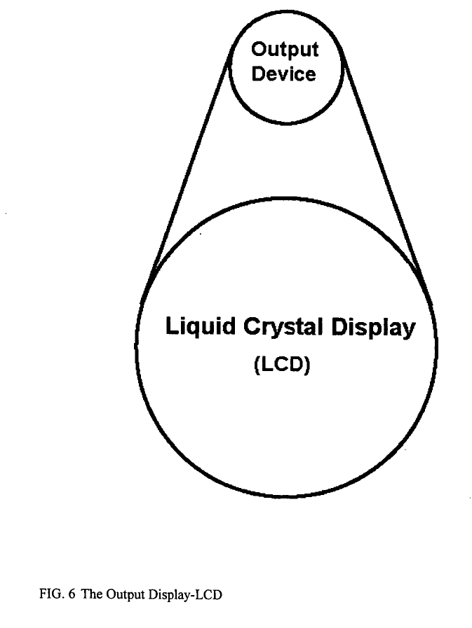

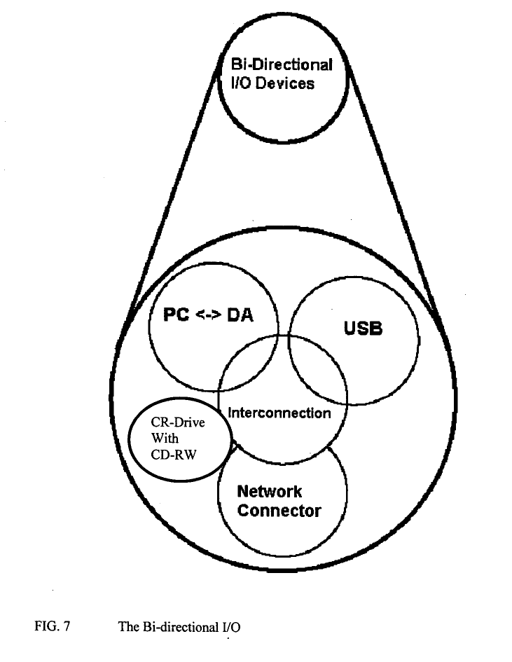

The “COMPUTER” of this system will be the brain of the system. It will be responsible of carrying out all the manipulations of the system. This is the processor of the system. The processor of this system does not need any complicated logic. It is a simple processor, capable of loading, retrieving, storing, forward, backward, and able to manipulate digital pictures and images. See FIGS. 3a and 3b.

The system carry's some form of nonvolatile memory to either hold permanent/temporary data in the system. See figures to depict memory.

Furthermore, CD-drive.

The desktop, wallmount, and server versions (described below) will in addition come with a CD-drive as an input to the system and for backing up, and storing. This means that, the system is and capable of not only a CD-Rom but also CD-RW.

The most important drives of the DigiAlbum are the memory stick/card drives. These drives are important because they will be the only source for some digital camera owners; since they may not have a personal computer or some other connection capability from their camera to other devices.

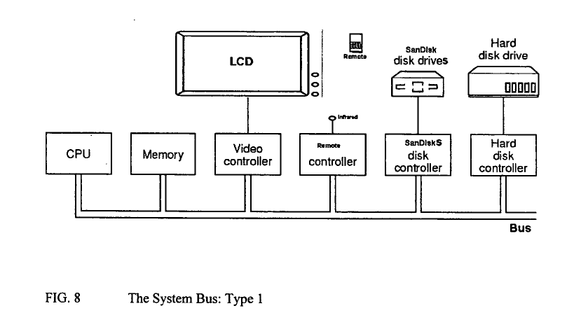

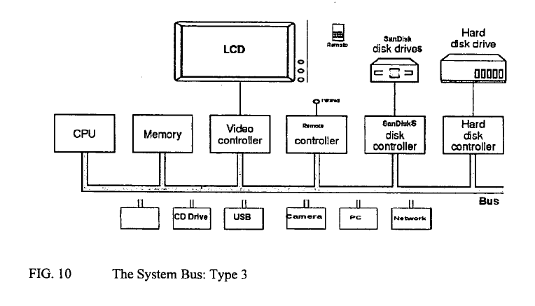

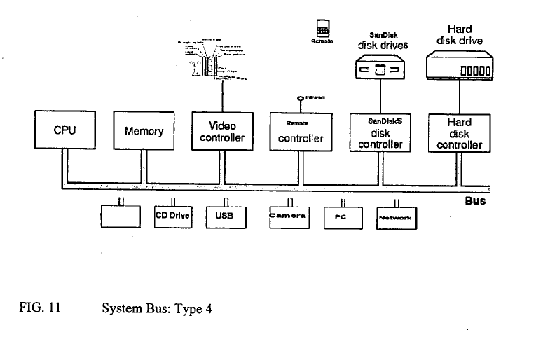

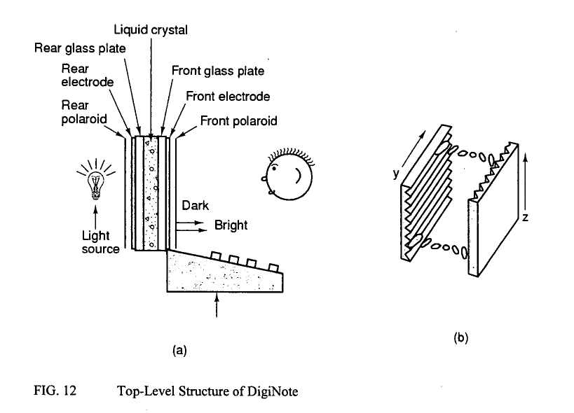

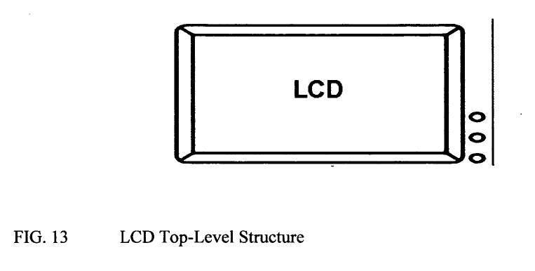

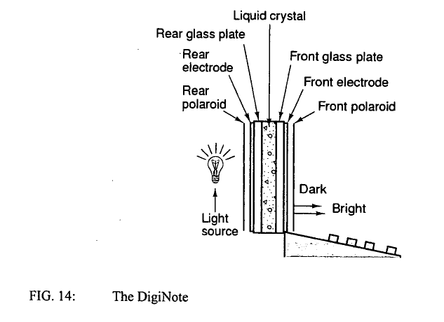

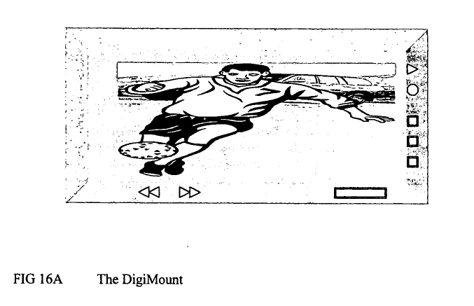

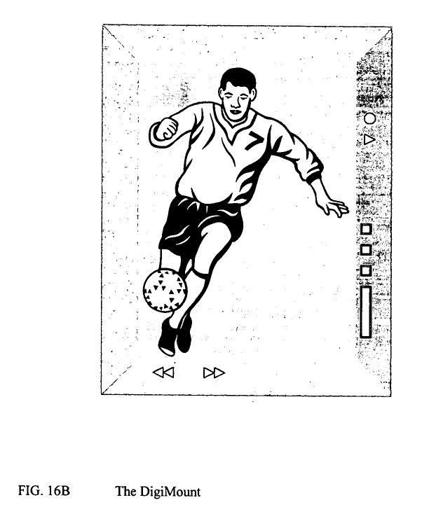

These drives will be used as an input to the system to display photos desired. As already known, each memory card is limited by capacity, as some may carry very small quantity while others will carry very large quantity. With this in mind, and as memory card technologies defer, this system comes with one of the most popular drive and provide a USB port to support the least popular cards/sticks. See system Bus FIGS. 8, 9, 10 and 11 to depict memory card drive. As depicted in the figures, all of these systems come with more than one stick/card drives. This means that, more than one card/stick can be on the system at the same time.

The most important port next to the stick/card drives is the port to connect to a digital camera. This port will help users to download their photos right from their digital camera internal memory to DigiAlbum.

Power supply, it will be better off to have a power supply on these systems, that's why I have added it since battery usage will not be the best option for all of these systems. Also, the usage of battery should be made available as an alternate source for energy in some of the systems like the DigiMin, DigiNote.

Control buttons, each system should come with:

Forward

Backward

Stop/Cancel

Pause buttons

Save

Delete

Power On/Off and

Other necessary buttons

These buttons come as a two, three, four, or more buttons mouse or as a remote and/or as buttons placed on the front platform of the system. Depending on the type, some of the system will come with mouse and/or remote.

Mouse/Remote

If a mouse is used for control, let one of the buttons be specified to click on commands on the screen, while the others can be specified accordingly. The mouse described here is remote-like, either wireless or wire. The wireless is what I view as to four or more buttons mouse. Of course there is a remote described here, which is not similar to the mouse but more like our TV remote. This remote will have all necessary buttons needed to control the DA.

See System Bus figures to depict remote and remote controller.

Whether or not a mouse or remote is provided, these buttons are made available on the front panel of the system. To be flexible, both the front panel and the mouse buttons can be provided.

The DigiAlbum comes in different sizes and in different shapes. Also, other ports and buttons may be needed for individual preference/design.

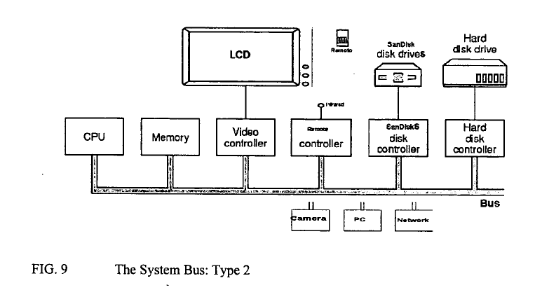

All of these systems will have access to a network (optional), whereby allowing viewers of these photos to export copies or for printing. See FIG. 9, 10, and 11 to depict the network feature. The user can edit each photo before sending it out. The original copy is password protected, so as to prevent it from deletion, over-written from an unauthorized person.

The system will have the “Photo Agent” permission before sending out photo(s). This does not mean that the photo agent is responsible for the cost of the printing/distribution. This is to show that the owner know his/her photo(s) are been sent out; (not everyone would allow their photos to be sent or given out). Also, “Photo Manager” be made available; this is a software.

These system, especially the desktop and the wallmount discussed below, should be made such that, when ON should sequentially display photos in its internal memory without the user intervention. The user can roll back and forth, fast forward or rewind. The display of each photo should be based on the user setting; that is, the user must be given configuration rights to set his/her desired pulse/delay time for each photo display. A power saver mode should be made available such that power utilization will be minimal.

Types of Digialbum:

DigiDesktop

DigiServer

DigiHandheld

DigiMount

DigiMin

DigiNote

### DigiDesktop

The first of these proposals is the “DigiAlbum Desktop”. This desktop, unlike your personal computer does not have a PC and a monitor sitting side by side. Rather, only one flat (optional) monitor-like is required, which contains everything that one could possibly need to store, view and manipulate photos.

The specification for this system should be clear that it is not a computer and a side by monitor; it is just one system.

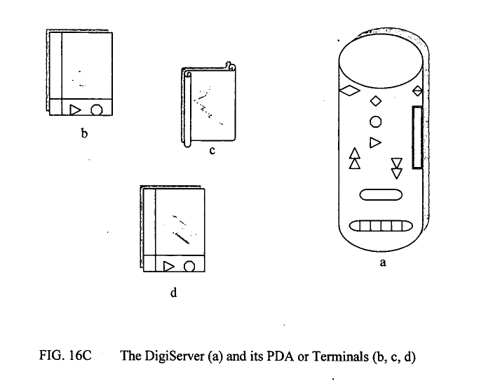

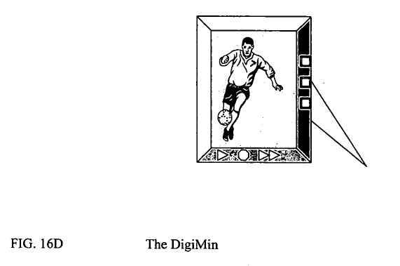

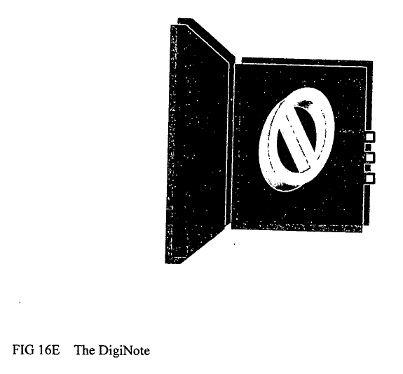

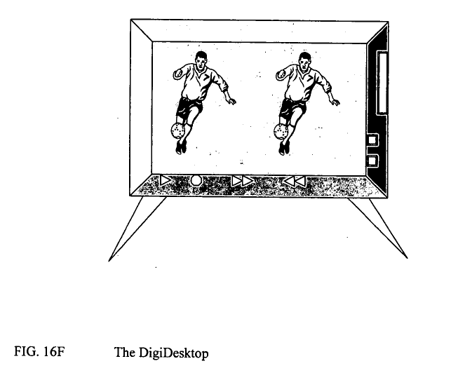

This system can also be made available for remote control. There is no specific design for the remote, other than what is described for the mouse/remote. See FIG. 16a, and 16b to envision a finished product of the DigiDesktop.

### DigiServer

The “DigiAlbum Server”, this specification is absolutely different from the Desktop version. It comprises of a

Main system and

Subsystems/Terminals/PDAs

Monitor (optional)

That is, a mini server (Database) capable of holding large quantity of data, it should be able to transmit information to and from other terminals.

These other terminals (subsystems) are intended to be wireless and should have the capability of accessing the server from a specified, reasonable range.

To reduce cost, and increase speed, the wireless version can be made optional and wires can be used. But this is the actual objective of the server version of the DigiAlbum. There should be wireless (optional) handheld PDA-like which is capable of accessing the server. These handheld do not need any complexity as their PDA counterparts.

The server version contains similar external connectivity as the Desktop version, especially at the back panel. In addition, necessary ports to connect the terminals are also provided. This server is a multi-user; otherwise it is not different from the desktop version.

The optional monitor is for central use purposes, such as configuring the server.

It can also be made as the Desktop version wherefore allowing the Desktop to access the server (wireless preferred). This does not give this system the status of monitor and a side by computer.

The purpose of this server is to be able to share resources among users. It comes with a monitor, and has wireless PDA's as mentioned above. If this version does not come with the PDA's, its intended purpose is lost. See FIG. 16c to envision a finished product of the DigiServer.

### DigiMount

This is a flat panel, slim enough so as to be mounted on the wall. DigiWallMount is another form of the desktop version, but flat to be mounted on the wall. It comes with a remote control; this is not an option to the user since it is a wall mount and requires flexibility. See FIGS. 16a, 16b to envision a finished product of the DigiMount.

### DigiMin

A DigiMin is somewhat slim, preferably 8×10. This system will be used mostly in the offices. It is similar to the desktop version of the DigiAlbum but without a CDdrive. While the DigiMin will be a mobile tool, it contains drives/ports such as:

Memory card/stick.

DCDA port

It will be better off to have a DC power supply on this system, that's why I have added it since battery usage will not be the best option.

Battery compartment

The usage of battery should be made available as an alternate source for energy supply since it is mobile.

This system has the operative buttons that the desktop version has. It is limited to photo view/display. See FIG. 16d to envision a finished product of the DigiMin.

It is not available for photo edits, imports, and exports to and from another system.

To make it become more fancy, one may decide to provide these excluded features by adding network source, preferably wireless.

The system will be able to retrieve from a digital camera.

Large internal permanent memory for this system is not recommended as it will in most cases use a memory card/stick, and as photos are always going to be rotated. This system is not a storage. This system is available for modification, but let it be known, the general objective of the system.

### DigiNote

The DigiNote is more like the current paper photo album but without paper printed photos. It has cover (see FIG. 16e), multiple sources for memory cards/sticks, battery compartment, DC power, and the other ports already mentioned above. It also has all the control buttons already mentioned above.

### Software

Types of Software:

DigiOps

DigiSoft (PhotoSoft)

Other Utilities

### DigiOps

The DigiAlbum comes with an operating system called DigiOps. This is the systems software; it is responsible for the operational processes of the system, and interacts with the hardware of the system and the PhotoSoft.

### Photo Agent (‘DigiOwn’)

“Photo Agent” is a virtual owner of the photos stored in the system.

### Photosoft (‘DigiSoft’) Manager

The DigiAlbum comes with application software called PhotoSoft (Photo Manager). It has the control of the user interface and responsible for coordinating the interaction between the user and the operational processes of the system.

### Talking Point

These systems are not only beneficial to digital camera users, but also beneficial to other camera users as well. If you can have your photos made digital either by scanning or using one of the available conversion means, you are all set to use DigiAlbum.

Some will come to call it a new TV, some will call it electronic album, others will call it just album, I call it DigiAlbum.

Hey, how about having a new TV with one additional mode: Album mode. Or simply add one more input source in your TV not an external, maybe a port to plug a memory card/stick. Simply put your TV on Album mode and you are all set. There are figures in this document that may not have been mentioned in other parts of the document but, these figures with the labels, explain themselves and depict what they are for.

### Conclusion

It's not TV; It's not PC; It's a DA.

The DA designed for use by corporations, schools, students, in stores, professional, in cars, trains, boats, airplanes, churches, and in homes; It is virtually made for everybody or group of persons and in everywhere.

It is designed in various models to fit stipulated environment and easy to use. The hassles of cellophane sticking on your pictures will be a thing of the past. You do not need to wait for film development or printing, so easy that after every round of snap shots, your photos could simply be plugged-in or downloaded for viewing.

What I claim as my invention is:

1. A digital photo album with a memory stick/card drives, wherein digital photos and images can be transmitted and be displayed on an LCD of the DigiAlbum or stored in the internal memory of the unit.

2. A digital photo album with DCDA port wherein a digital camera can be connected to the digital album for the purpose of storing and viewing digital and analog images and pictures.

3. A digital photo album that manipulate and display not only digital images and pictures but also analog images and pictures.

4. A digital photo album that share photos in a domain among multiple users in a house, office, museum, etc. without an external host.

5. The claims made herein, are not only what this invention offer. More claims are embedded in the detailed documentation of the invention.

6. An automated digital photo album for the purpose of storing and displaying of both digital and analog images and pictures.

7. A digital photo album that is intended to replace the existing paper photo albums.

8. An automated digital photo storage system for the display of photographic images and pictures.
